(19) United States
(12) Patent Application Publication
(10) Pub. No.: US 2024/0104306 A1
(43) Pub. Date: Mar. 28, 2024

(54) COLLABORATION CONTENT GENERATION AND SELECTION FOR PRESENTATION

(71) Applicant: Avaya Management L.P., Durham, NC (US)

(72) Inventors: Prateek Singh, Noida (IN); Kavitha RS, Bangalore (IN); Raghav Krishnakant Kanojia, Vadodara (IN); Gaurang Jayantibhai Gohil, Ahmedabad (IN)

(21) Appl. No.: 17/950,974

(22) Filed: Sep. 22, 2022

(51) Int. Cl. G06F 40/35; G06N 3/08

(52) U.S. Cl. CPC G06F 40/35; G06N 3/08

(57) ABSTRACT

Electronic conferences between networked communication devices often comprise conference content comprising a visual element that may be supplemented with additional conference content, such as speech from a presenter or other inputs (e.g., mouse pointer gestures). An artificial intelligence, such as a neural network, may be trained to receive the conference content and determine a conference topic. The neural network may then select or generate a digital asset that supports, enhances, or otherwise aids understanding of the conference topic. The digital asset may automatically, or upon approval or selection, be provided to the conference as conference content. Digital assets that prove popular may be added to a repository, such as a blockchain, for access and use by others.

### FIELD OF THE DISCLOSURE

The invention relates generally to systems and methods for automatic insertion of conference content into a conference and particularly to artificial intelligence determining a conference topic and a digital asset associated with the conference topic.

### BACKGROUND

During an electronic conference a presenter may wish to present a digital asset (e.g., video clips, images, GIFs, etc.) to the other participants. In order to maintain the flow of the conference, the presenter must be able to quickly identify the particular digital asset desired, which may be one of many; select the intended file for the digital asset; and send the digital asset or present the digital asset on a screen shared with the other participants. In practice each of the foregoing steps can be time consuming and error prone. As a result, the electronic conference is interrupted and the flow broken in order to present the digital asset to the participants, assuming the process is successful and the digital asset does eventually get presented. For example, the digital asset may require a web search and force the presenter to manually wade through many, often a large number, of incorrect options. Some digital assets may require a particular application for presentation, such as a video player. Such an application may load slowly, fail completely, or require an update before becoming operational, further adding to the disruption.

### SUMMARY

In one embodiment, an artificial intelligence (AI) generates relevant digital assets that may be used by a user interface (UI) in a video conference or collaboration environment product such as Avaya Spaces™ and thereby improve the exchange of information. An artificial intelligence (AI) agent monitors the content exchanged (e.g., speech, in-conference text messages, etc.) and recommends a digital asset to visually present relevant content to the conference. Additionally or alternatively, the digital assets may be, or be converted to, non-fungible tokens (NFTs) and licensed for subsequent use in other conferences.

In another embodiment, the AI listens to and/or watches online collaboration meetings comprising video (herein, a “conference”) and generates digital assets such as video clips, GIFs, images (e.g., diagrams, charts, etc.) for sharing in the conference. The resulting digital asset may then be added to an organization's storage, such as a blockchain, and optionally made available or provided to the participants of the conference and/or others. The digital assets are privileged and may include snippets from all the sharing done by the presenter.

The AI may also listen to all the collaboration meetings and generate recommended previously generated digital assets. The recommendation for a particular digital asset may be based, at least in part, on attributes of the participants or audience.

In another embodiment, a conference presenter explaining a concept may wish to share with the audience a video clip, GIF, or image as an aid to promote understanding of the concept. The presenter may not have the digital content available on his laptop. In the prior art, the presenter might open a web browser, perform a web search, and share the screen presenting the search results. Alternatively, the presenter may launch a drawing application, draw a diagram, and share the screen presenting the results. However, such interruptions to the conference are disruptive and time consuming. Accordingly, and in another embodiment, digital assets may be identified and presented in a “recommended” section of the conferencing application. The digital assets may be recommended based on those available to a previously established group (e.g., enterprise, organization, department, team, etc.) or ad hoc group (e.g., conference participants). The presenter may then choose a digital asset from those recommended that, once selected, is provided as conference content for presentation to the participants of the conference. Additionally or alternatively, the presenter may preselect certain digital assets from the digital asset bank that is available or may rely on recommendations from the AI while presenting.

In another embodiment, an audience member of the presentation may hear an unfamiliar term being used. In the prior art, the audience member may perform a web search, which diverts attention away from the ongoing presentation. Accordingly, the AI may choose from audience-specific recommendations given by the AI in an audience recommendation section of the UI and select text, image, video, or another digital asset to explain the term, which may be customized for the audience or a particular member thereof. If the audience member selects a video clip, it will be played at a low volume to this particular audience member only and not to all the participants, and the original voice of the presenter will go into a background mode.

AI generates various digital assets and types of digital assets, which may include, but are not limited to, images, GIFs, video snapshots, frames cut near mouse movement, time limited video and/or audio, etc. In one embodiment, a certain image is discussed multiple times during a presentation. The AI saves this image and later recommends the image as a digital asset recommendation registered on a blockchain, which may be a blockchain limited to within an enterprise, department, etc., or otherwise excluded from the general public, and wherein the digital asset may initially be fungible tokens.

Generation of the digital assets are variously embodied. In one embodiment, the AI may generate a GIF based on its training and mouse movements from the presenter while presenting. The AI may clip multiple video frames to generate the GIF. In another embodiment, the AI may generate a video clip from ten to thirty seconds of the presentation that the AI determines can be reused in another meeting based on criteria and training as explained herein. In another embodiment, the AI may generate long videos based on presentation recordings, specifically, based on sentence and topic completion, and presenter voice cues. In another embodiment, the AI may generate audio clips based on audio presentation recordings, specifically, based on certain topics taken from the presentation recordings. In another embodiment, the AI, depending on its training, may recreate new assets and modify assets as new content that the AI determines are related.

The AI may be embodied as a neural network trained to generate and/or recommend digital assets for use in a conference. The AI is initially trained and may be subsequently trained, such as with continual feedback and/or selective feedback (e.g., identifying errors). The AI may be trained on cues. The cues may be, in part, rule based such as identifying relevant and/or irrelevant content for an enterprise or other group.

In one embodiment, the AI only listens to portions of speech provided in the conference (voice tags), and when a voice tag fits the rule, the AI will start creating the short video asset or audio asset. In another embodiment, the AI may only do image processing based on certain images on which the AI is trained based on the organization's specific images. For example, the AI may process a particular audio cue (e.g., “sip”) based on the organization. If the organization is a beverage company, the AI may focus on drinking beverages, whereas if the organization is a telephony company, the AI may focus on Session Initiation Protocol (“SIP”).

If an image (digital asset or otherwise) is shared during the conference and the presenter gestures with a mouse pointer, such as circling a portion of the image, the AI may then evaluate the mouse movements and, in response, take a snapshot of the circled content and create an image snapshot. If the time the particular portion of the image is discussed is beyond a threshold value, the AI may generate a more defined image in place of the image snapshot.

In another embodiment, the AI may process voice, image, and mouse and create video clips with the voice and content and the section of the video frame on which the mouse is moving like a gesture. If a term is frequently encountered, the AI may determine if it already has knowledge of the term and, if not, train itself such as extracting a meaning of the term via web search, usage context, and, if necessary, explicit prompting. If a term is new and no digital asset is associated with the term, but subsequent to a conference one is selected or generated, the digital asset may be shared with the participants after the meeting. When available, the AI may identify cues from other sources, such as emails associated with the conference.

In another embodiment, the AI can be trained using transfer learning or can be retrained/reinforcement trained by the user above organization level training. To train the personal assist functionality, the presenter may have a previous session with the AI and share the gestures of the mouse it usually uses while presenting. The previous session may be exclusively a training session (e.g., provide gestures for no other purpose other than to train the AI) or a prior conference. The AI may also be trained over time as it listens to a presenter's dialogue delivery, voice imprint, and characteristic concluding statements for ending a presentation so that the AI does not cut him off at an inappropriate time.

In another embodiment, the generated digital assets may be, at least initially, fungible tokens. After each meeting, the presenter will get modified and augmented videos of his contribution to the meeting from the AI. These videos are fungible digital tokens and are not yet NFTs. The presenter may review the videos and select and add the videos to his own recommendation pool. The user may indicate whether the videos are useful to others in the organization and/or recommend the organization publicly post the assets on the public NFT marketplace. The user may cause digital assets to be published as NFTs, which would make these NFTs part of the organization's common pool of digital assets. The organization's common pool of digital assets may be within intranet.

The digital assets may or may not be made available publicly, such as based on an automated rule or policy, and/or the popularity of the digital asset within the organization. Once publicly published, the digital assets become non-fungible. The owner may be the presenter, employer of the presenter, or other organization. The AI may recommend digital assets from the pool of private and/or public repositories, such as blockchain(s). Digital assets having a reuse or re-reference beyond a previously determined threshold may be publicly published, such as in an NFT form.

An owner of a digital asset (e.g., employer of a conference presenter) may publicly publish digital assets. The determination may be based, at least in part, on the popularity of the digital asset within the organization. The organization may check that the digital assets are non-confidential and are permitted to be published outside the organization. Different organizations may use this service using representational state transfer (REST) or any state of art technology to fetch all of these organization-owned digital assets. The owner may attach a license to the assets and require potential users to know the license terms. The license terms may allow or not allow re-publishing of the content, modification of the content, limiting the number of views, having a price for the content, having a price for a bundle of digital assets that include the content, package terms, etc. The owner can post the license terms publicly with ownership as their own such that they can be used by a wider audience in different organizations including potential collaborators.

Other organizations may fetch the digital assets from a public pool of available digital assets. An organization may purchase under license relevant NFTs from another organization.

The AI may efficiently assist the presenter of a conference. The presenter may give his full presentation to the AI before presenting live. The AI may generate insights that the presenter can share in his presentation. The presenter does not need to update presentation content himself. The AI will assist with creating content and combining old and new content. The AI may be a productivity tool to get recommendations as one speaks. In one embodiment, the presenter explains a concept and feels his audience is unable to understand. The presenter may share content recommended by the AI, or the audience members can individually listen to recommendations by the AI.

These and other needs are addressed by the various embodiments and configurations of the present invention. The present invention can provide a number of advantages depending on the particular configuration. These and other advantages will be apparent from the disclosure of the invention(s) contained herein.

Exemplary aspects are directed to:

A system, comprising: a data storage; a microprocessor coupled with a computer memory comprising computer readable instructions; wherein the microprocessor: receives a conference comprising conference content encoded therein and exchanged over a network between a plurality of communication devices, wherein the conference content comprises speech from at least one of the plurality of communication devices; identifies a conference topic from the conference content; determines a digital asset, from a pool of digital assets, that best matches the conference topic; and presents the digital asset to the plurality of communication devices as a portion of the conference content.

A computer-implemented method, comprising: receiving a conference comprising conference content encoded therein and exchanged over a network between a plurality of communication devices, wherein the conference content comprises speech from at least one of the plurality of communication devices; identifying a conference topic from the conference content; determining a digital asset, from a pool of digital assets, that best matches the conference topic; and presenting the digital asset to the plurality of communication devices as a portion of the conference content.

A system, comprising: means to receiving a conference comprising encoded conference content exchanged over a network between a plurality of communication devices, wherein the conference content comprises speech from at least one of the plurality of communication devices; means to identify a conference topic from the conference content; means to determine a digital asset, from a pool of digital assets, that best matches the conference topic; and means to present the digital asset to the plurality of communication devices as a portion of the conference content.

Any of the above aspects:

Wherein the microprocessor determines that the digital asset that best matches the conference topic by providing the conference content to a neural network trained to determine the conference topic from the conference content and select the digital asset best matching the conference topic.

Wherein the neural network is trained, the training comprising a computer-implemented method of training the neural network for conference topic detection, comprising: collecting a set of words associated with conference topics from a database; applying one or more transformations to each set of words including substituting a word with a synonymous word, substituting a word with a synonymous phrase, inserting at least one redundant word, or removing at least one redundant word to create a modified set of conference topics; creating a first training set comprising the collected set of words, the modified set of conference topics, and a set of words unrelated to any of the conference topics; training the neural network in a first stage using the first training set; creating a second training set for a second stage of training comprising the first training set and the set of words that are incorrectly determined to be associated with the conference topic after the first stage of training; and training the neural network in a second stage using the second training set.

Wherein the microprocessor determines that the digital asset that best matches the conference topic is an insufficient match and, in response, provides the conference content to a neural network trained to generate digital assets from the conference topic.

Wherein the neural network is trained, the training comprising a computer-implemented method of training the neural network for digital asset generation comprising: collecting a set of digital assets associated with prior conference topics from a database; applying one or more transformations to each set of digital assets including substituting a portion of ones of the set of digital assets with a synonymous digital asset, substituting a graphical element with a synonymous graphical element, inserting at least one graphical element into at least one of the set of digital assets, or removing at least one graphical element from at least one of the set of digital assets to create a modified set of digital assets; creating a first training set comprising the collected set of digital assets, the modified set of digital assets, and a set of digital assets unrelated to the prior conference topics; training the neural network in a first stage using the first training set; creating a second training set for a second stage of training comprising the first training set and the set of digital assets that are incorrectly determined to match a prior conference topic after the first stage of training; and training the neural network in the second stage using the second training set.

Wherein the set of digital assets comprise previously generated digital assets during previous conferences.

Wherein the microprocessor further generates a non-fungible token encoding therein the digital asset and adds the non-fungible token to a first blockchain.

Wherein the microprocessor, upon determining the non-fungible token has been accessed a number of times that exceeds a previously determined threshold, automatically adds the non-fungible token to a second blockchain.

Wherein the microprocessor determines the digital asset that best matches an attribute of the conference.

Wherein the microprocessor determines the digital asset that best matches an attribute of a current speaking participant of the conference.

Wherein determining the digital asset that best matches the conference topic comprises providing the conference content to a neural network trained to determine the conference topic from the conference content and select the digital asset best matching the conference topic.

Wherein the neural network is trained, the training comprising a computer-implemented method of training the neural network for conference topic detection, comprising: collecting a set of words associated with conference topics from a database; applying one or more transformations to each set of words including substituting a word with a synonymous word, substituting a word with a synonymous phrase, inserting at least one redundant word, or removing at least one redundant word to create a modified set of conference topics; creating a first training set comprising the collected set of words, the modified set of conference topics, and a set of words unrelated to any of the conference topics; training the neural network in a first stage using the first training set; creating a second training set for a second stage of training comprising the first training set and the set of words that are incorrectly determined to have the conference topic after the first stage of training; and training the neural network in the second stage using the second training set.

Further comprising determining that the digital asset that best matches the conference topic is an insufficient match and, in response, providing the conference content to a neural network trained to generate digital assets from the conference topic.

Wherein the neural network is trained, the training comprising a computer-implemented method of training the neural network for digital asset generation comprising: collecting a set of digital assets associated with prior conference content from a database; applying one or more transformations to each set of digital assets including substituting a portion of ones of the set of digital asset with a synonymous digital asset, substituting a graphical element with a synonymous graphical element, inserting at least one graphical element into at least one of the ones of the set of the graphical assets, or removing at least one graphical element from at least one graphical asset to create a modified set of conference content; creating a first training set comprising the collected set of digital assets, the modified set of digital assets, and a set of digital assets unrelated to the conference content; training the neural network in a first stage using the first training set; creating a second training set for a second stage of training comprising the first training set and the set of digital assets that are incorrectly determined to match the conference content after the first stage of training; and training the neural network in the second stage using the second training set.

Wherein the set of digital assets comprise previously generated digital assets during previous conferences.

Further comprising generating a non-fungible token encoding therein the encoded digital asset and adding the non-fungible token to a first blockchain.

Further comprising, upon determining that the non-fungible token has been accessed a number of times that exceeds a previously determined threshold, automatically adding the non-fungible token to a second blockchain.

Further comprising, upon determining the digital asset that best matches the conference topic, determining the digital asset that best matches at least one of an attribute of the conference or a current speaking participant of the conference.

A system on a chip (SoC) including any one or more of the above aspects or aspects of the embodiments described herein.

One or more means for performing any one or more of the above aspects or aspects of the embodiments described herein.

Any aspect in combination with any one or more other aspects.

Any one or more of the features disclosed herein.

Any one or more of the features as substantially disclosed herein.

Any one or more of the features as substantially disclosed herein in combination with any one or more other features as substantially disclosed herein.

Any one of the aspects/features/embodiments in combination with any one or more other aspects/features/embodiments.

Use of any one or more of the aspects or features as disclosed herein.

Any of the above aspects, wherein the data storage comprises a non-transitory storage device, which may further comprise at least one of: an on-chip memory within the processor, a register of the processor, an on-board memory co-located on a processing board with the processor, a memory accessible to the processor via a bus, a magnetic media, an optical media, a solid-state media, an input-output buffer, a memory of an input-output component in communication with the processor, a network communication buffer, and a networked component in communication with the processor via a network interface.

It is to be appreciated that any feature described herein can be claimed in combination with any other feature(s) as described herein, regardless of whether the features come from the same described embodiment.

The phrases “at least one,” “one or more,” “or,” and “and/or” are open-ended expressions that are both conjunctive and disjunctive in operation. For example, each of the expressions “at least one of A, B, and C,” “at least one of A, B, or C,” “one or more of A, B, and C,” “one or more of A, B, or C,” “A, B, and/or C,” and “A, B, or C” means A alone, B alone, C alone, A and B together, A and C together, B and C together, or A, B, and C together.

The term “a” or “an” entity refers to one or more of that entity. As such, the terms “a” (or “an”), “one or more,” and “at least one” can be used interchangeably herein. It is also to be noted that the terms “comprising,” “including,” and “having” can be used interchangeably.

The term “automatic” and variations thereof, as used herein, refers to any process or operation, which is typically continuous or semi-continuous, done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

Aspects of the present disclosure may take the form of an embodiment that is entirely hardware, an embodiment that is entirely software (including firmware, resident software, micro-code, etc.) or an embodiment combining software and hardware aspects that may all generally be referred to herein as a “circuit,” “module,” or “system.” Any combination of one or more computer-readable medium(s) may be utilized. The computer-readable medium may be a computer-readable signal medium or a computer-readable storage medium.

A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible, non-transitory medium that can contain or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device. Program code embodied on a computer-readable medium may be transmitted using any appropriate medium, including, but not limited to, wireless, wireline, optical fiber cable, RF, etc., or any suitable combination of the foregoing.

The terms “determine,” “calculate,” “compute,” and variations thereof, as used herein, are used interchangeably and include any type of methodology, process, mathematical operation or technique.

The term “means” as used herein shall be given its broadest possible interpretation in accordance with 35 U.S.C., Section 112(f) and/or Section 112, Paragraph 6. Accordingly, a claim incorporating the term “means” shall cover all structures, materials, or acts set forth herein, and all of the equivalents thereof. Further, the structures, materials or acts and the equivalents thereof shall include all those described in the summary, brief description of the drawings, detailed description, abstract, and claims themselves.

The preceding is a simplified summary of the invention to provide an understanding of some aspects of the invention. This summary is neither an extensive nor exhaustive overview of the invention and its various embodiments. It is intended neither to identify key or critical elements of the invention nor to delineate the scope of the invention but to present selected concepts of the invention in a simplified form as an introduction to the more detailed description presented below. As will be appreciated, other embodiments of the invention are possible utilizing, alone or in combination, one or more of the features set forth above or described in detail below. Also, while the disclosure is presented in terms of exemplary embodiments, it should be appreciated that an individual aspect of the disclosure can be separately claimed.

### BRIEF DESCRIPTION OF THE DRAWINGS

The present disclosure is described in conjunction with the appended figures:

FIG. 1 depicts a system in accordance with embodiments of the present disclosure;

FIG. 2 depicts a system in accordance with embodiments of the present disclosure;

FIG. 3 depicts a process in accordance with embodiments of the present disclosure;

FIG. 4 depicts a process in accordance with embodiments of the present disclosure;

FIG. 5 depicts a process in accordance with embodiments of the present disclosure;

FIG. 6 depicts a process in accordance with embodiments of the present disclosure; and

FIG. 7 depicts a system in accordance with embodiments of the present disclosure.

### DETAILED DESCRIPTION

The ensuing description provides embodiments only and is not intended to limit the scope, applicability, or configuration of the claims. Rather, the ensuing description will provide those skilled in the art with an enabling description for implementing the embodiments. It will be understood that various changes may be made in the function and arrangement of elements without departing from the spirit and scope of the appended claims.

Any reference in the description comprising a numeric reference number, without an alphabetic sub-reference identifier when a sub-reference identifier exists in the figures, when used in the plural, is a reference to any two or more elements with the like reference number. When such a reference is made in the singular form, but without identification of the sub-reference identifier, it is a reference to one of the like numbered elements, but without limitation as to the particular one of the elements being referenced. Any explicit usage herein to the contrary or providing further qualification or identification shall take precedence.

The exemplary systems and methods of this disclosure will also be described in relation to analysis software, modules, and associated analysis hardware. However, to avoid unnecessarily obscuring the present disclosure, the following description omits well-known structures, components, and devices, which may be omitted from or shown in a simplified form in the figures or otherwise summarized.

For purposes of explanation, numerous details are set forth in order to provide a thorough understanding of the present disclosure. It should be appreciated, however, that the present disclosure may be practiced in a variety of ways beyond the specific details set forth herein.

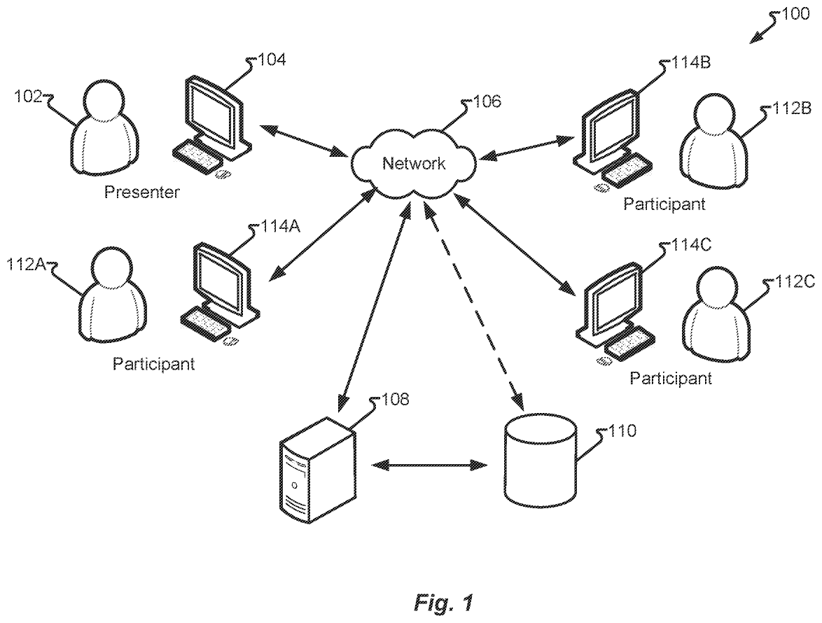

FIG. 1 depicts system 100 in accordance with embodiments of the present disclosure. In one embodiment, presenter 102 and participant 112A-C are engaged in a conference over network 106 utilizing presenter communication device 104 and communication device 114A-C, respectively. The conference comprises conference content (e.g., speech, co-browsing inputs such as mouse pointer movements, video, screen sharing, document sharing, media sharing, etc.) originating from any one or more of presenter communication device 104 and/or communication device 114A-C. System 100 illustrates one topology of components interconnected via network 106. Server 108 may be connected to presenter communication device 104 and each of communication device 114A-C via network 106 and directly connected to data storage 110. Additionally or alternatively, data storage 110 may be connected to network 106 and accessible to server 108 via network 106. One of ordinary skill in the art will appreciate that other network topologies may be utilized without departing from the scope of the embodiments described herein.

The conference utilizes conferencing hardware (e.g., ports, hubs, switches, routers, etc.) configured with a conferencing application of a processor, which may be embodied as a stand-alone device (not shown) or integrated with server 108 (as illustrated). Server 108 comprises a microprocessor having instructions maintained in a non-transitory computer memory to cause the microprocessor to monitor the conference content provided to the conference. For example, presenter 102 may be speaking into a microphone (not shown) that is a component of, or peripheral device of, presenter communication device 104 to convert the speech into analog and/or digital signals for processing and transmission via network 106 as a portion of the conference content. Server 108 receives the conference content, including the speech.

In one embodiment, server 108 analyzes the speech for one or more conference topics. The analysis of the speech is variously embodied. The conference topic is generally associated with a meaning of what is currently being discussed or otherwise presented in the conference. Server 108 performs machine-based natural language understanding to determine the conference topic. Natural language understanding is variously embodied to extract a meaning of the words said. Additionally or alternatively, server 108 considers other inputs, such as mouse pointer gestures and the target of such gestures (e.g., circling a particular item being displayed on a shared screen portion of the conference content) to determine the conference topic.

Embodiments of server 108 include any of one or more of analyzing words, syntax, semantics, pragmatics, and morphology; development of a structured ontology; determination of intent; and determination of entity. For example, server 108 may receive speech and determine a “bag” of n-gram words and, from the bag of n-gram words, determine the intent (e.g., explain an issue, reach an agreement to resolve a problem, determine a next step in a new process, troubleshoot an issue, etc.) and the entity (e.g., a customer having a faulty component, a process under development, a hardware component having an unusual fault, etc.). Generally, there are two types of entities: named entities and numeric entities. Named entities are grouped into categories such as people, companies, and locations. Numeric entities are recognized as numbers, currencies, and percentages. In another embodiment, lemmatization may be utilized to analyze the speech which is an organized and step-by-step procedure of obtaining the root form of the word. Lemmatization returns the lemma, which is the root word of all its inflection forms. Additionally or alternatively, stemming may be utilized, which is a quicker, but less accurate, means by which the root form of a word may be found by cutting of the suffix and certain prefixes of a word to obtain the root (i.e., stem) form. For example, the stem of ‘walking’ and ‘walked’ is ‘walk’ and the lemma of ‘was’ is ‘be’, the lemma of “rats” is “rat,” and the lemma of ‘mice’ is ‘mouse’. Further, the lemma of ‘meeting’ might be ‘meet’ or ‘meeting’ depending on its use in a sentence. By utilizing the foregoing, or other natural language understanding methodology(ies), server 108 may determine a meaning and/or a conference topic being discussed.

Server 108 may, or may not, consider the entire corpus of a language as a candidate for a potential conference topic. For example, server 108 may access known conference topics from previous topics, topics from documents, presentation documents, etc., from data storage 110.

Server 108, in monitoring the conference content, determines if a digital asset (e.g., image, video, document, etc.) exists, such as in data storage 110, that is related to the conference topic currently being discussed. If server 108 determines a digital asset, the digital asset may be presented on presenter communication device 104 for selection and, if selected, be provided as a portion of the conference content presented on communication device 114A-C. Alternatively, the digital asset may automatically be presented as conference content to communication device 114A-C and/or presenter communication device 104 without first requiring selection/approval from presenter 102 on presenter communication device 104.

In another embodiment, if no digital asset exists, server 108 may generate an image based on machine learning, such as a neural network trained to generate images based on inputs received as a portion of the conference content. For example, “DALL-E mini”, now known as “Craiyon” (available at craiyon.com), receives a string of explicitly provided text and generates images based on the images. However, such images tend to be a graphical amalgamation of the words, and are often non-sensical as a whole. Herein, the meaning of the words, in context, such as explaining a workflow or data flows, is determined and utilized to direct the trained neural network to generate an image related to the conference topic. Additionally or alternatively, the business context of the conference, presenter, audience member(s), and/or their employer, customer, and/or vendor may target results to a particular line of work or industry.

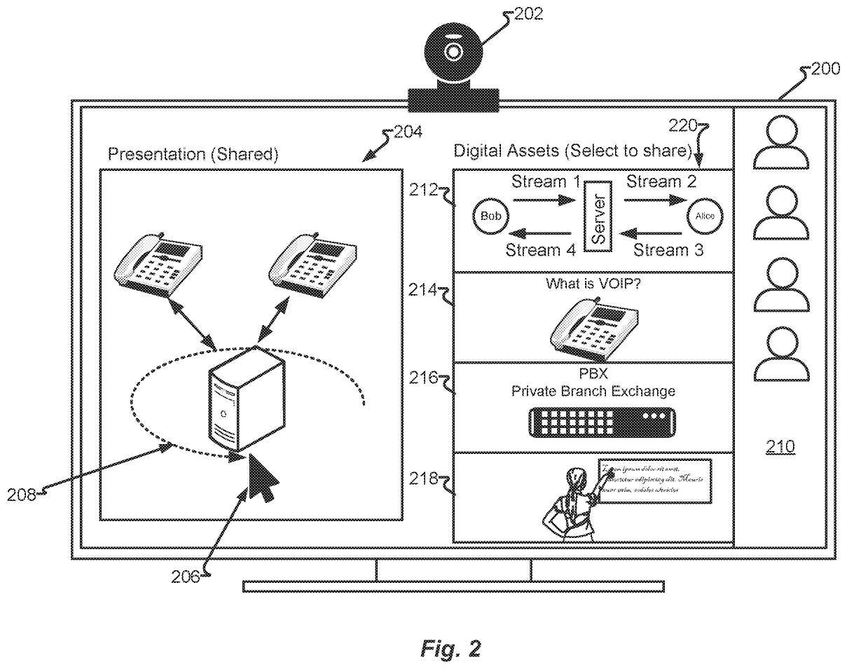

FIG. 2 depicts a communication device 200 in accordance with embodiments of the present disclosure. In one embodiment, communication device 200 is embodied as presenter communication device 104. Communication device 200 may comprise a variety of human input-output devices such as, but not limited to, camera 202 (which may further comprise a microphone and/or speaker), speakers, pointing device (e.g., mouse, trackpad, touch pad, etc.), keyboard, etc. in order to conduct a conference and provide conference content. Communication device 200 may comprise participants panel 210 to present video or avatar images of participants, presentation panel 204 providing shared content as a portion of the conference content, and digital asset panel 220 to present suggested digital assets that have been identified or generated.

A user, such as presenter 102, provides conference content in presentation panel 204 which is provided to each of the participants' communication devices (e.g., communication device 114A-C). Additionally, the user provides other content, such as speech and pointer gesture 208 with pointer 206. The neural network monitors the conference content, including what is said and other inputs (e.g., pointer gesture 208) to select and/or generate digital assets. For example, pointer gesture 208 is emphasizing a portion of the image presented in presentation panel 204 and, therefore, the neural network may determine the subject (e.g., a server) alone or with other inputs (e.g., speech) for determining the conference topic and digital assets that are related to the conference topic, whether or not the digital assets currently exist or require generation.

Existing digital assets may be identified and selected for use or if no sufficiently relevant digital asset exists, the digital asset(s) is then generated. For example, digital assets 212, 214, 216, and 218 are selected/generated for presentation on communication device 200 and either automatically presented to the participants' communication devices or presented for selection for inclusion as conference content. Digital assets are variously embodied and may include, but are not limited to, a graphic (digital asset 212), an external asset (digital asset 214), an internal asset (digital asset 216), or a video (digital asset 218). The digital assets in digital asset panel 220 may be selected or generated by the neural network or a combination thereof.

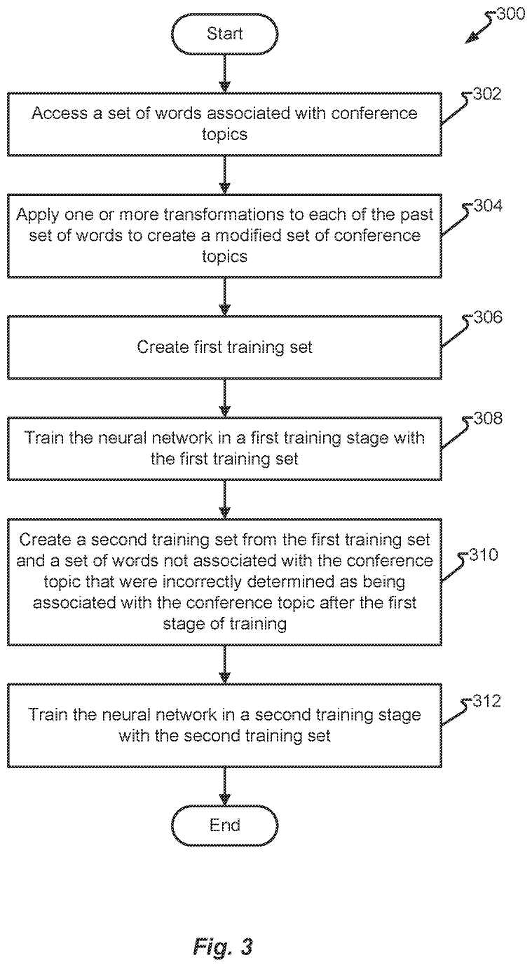

FIGS. 3-6 each depict a process (processes 300, 400, 500, and 600, respectively) in accordance with embodiments of the present disclosure. In one embodiment, any of one or more of processes 300, 400, 500, or 600 are embodied as machine-readable instructions maintained in a non-transitory memory that when read by a machine, such a microprocessors of a server, cause the machine to execute the instructions and thereby execute the one or more processes. The microprocessor of the server may include, but is not limited to, at least one processor of server 108.

FIG. 3 depicts process 300 in accordance with embodiments of the present disclosure. In one embodiment, process 300 trains a neural network such that conference content may be provided to the neural network for training thereon and/or to receive therefrom a digital asset associated with the particular conference content being discussed. In one embodiment, a neural network is trained at one time before use. In another embodiment, the neural network is trained and subsequently receives one or more reinforcement/error correction trainings, such as to emphasize prior correct decisions, so that similar conference content is more likely to produce similar digital assets in the future, and/or to de-emphasize prior incorrect decisions, so that similar conference content is less likely to produce similar digital content in the future. In a further embodiment, reinforcement/error correction training may occur continually upon receiving indicia of success or failure of a particular digital asset that was generated.

A neural network, as is known in the art and in one embodiment, self-configures layers of logical nodes having an input and an output. If an output is below a self-determined threshold level, the output is omitted (i.e., the inputs are within the inactive response portion of a scale and provide no output). If the self-determined threshold level is above the threshold, an output is provided (i.e., the inputs are within the active response portion of a scale and provide an output). The particular placement of the active and inactive delineation is provided as a training step or steps. Multiple inputs into a node produce a multi-dimensional plane (e.g., hyperplane) to delineate a combination of inputs that are active or inactive.

In one embodiment, process 300 begins and, at step 302, a set of words are accessed that are associated with conference topics. For example, a number of past conferences and/or other sources of the words may be accessed as well as their meaning, such as relation to a particular one or more of the conference topics. Step 304 applies one or more transformations to each of the past set of words to create a modified set of conference topics. Transformations may include, but are not limited to, one or more of substituting a word with a synonymous word, substituting a word with a synonymous phrase, inserting at least one redundant word, or removing at least one redundant word.

Step 306 then creates a first training set comprising the set of words associated with a conference topic and the modified set of words. Step 308 trains the neural network in a first stage of training with the first training set. Step 310 creates a second training set from the first training set and a set of words not associated with the conference topics or a particular conference topic that were incorrectly determined as being associated with the conference topic after the first stage of training. Step 312 then trains the neural network in a second stage of training with the second training set.

In another embodiment, process 300 is performed with non-word inputs (e.g., mouse pointer gestures) alone or in conjunction with the words. Process 300 may then end or be repeated such as to reinforce correct decisions and correct incorrect decisions.

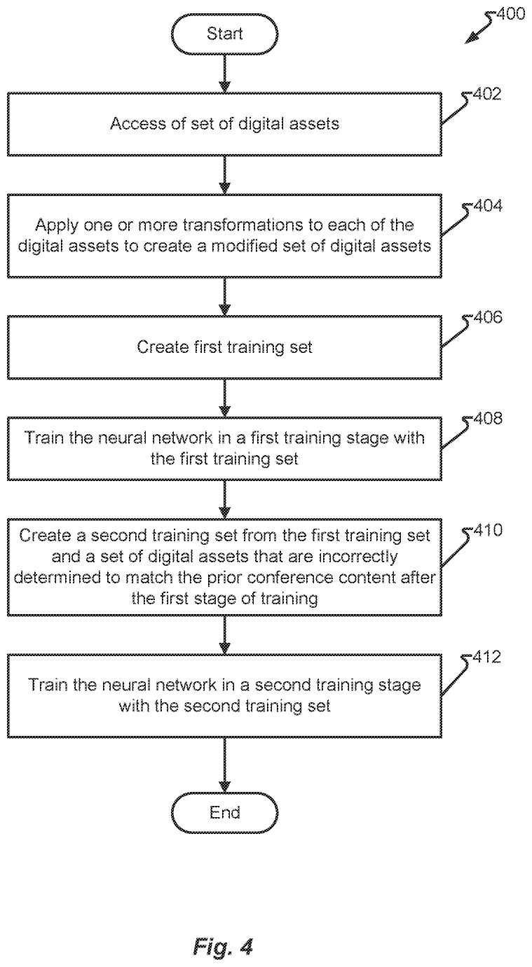

FIG. 4 depicts process 400 in accordance with embodiments of the present disclosure. In one embodiment, process 400 begins and, in step 402, accesses a set of digital assets. Step 404 applies one or more transformations to each of the digital assets to create a modified set of digital assets. The transformations include, but are not limited to, one or more of substituting a portion of a digital asset with a synonymous digital asset, substituting a graphical element with a synonymous graphical element, inserting at least one graphical element into at least one of the graphical assets, or removing at least one graphical element from at least one graphical asset.

Step 406 creates the first training set from the set of digital assets, the modified set of digital assets, and a set of words unrelated to any of the conference topics. Step 408 trains the neural network in the first stage of training with the first training set.

Step 410 creates a second training set from the first training set and a set of digital assets that are incorrectly determined to match the prior conference content after the first stage of training. Step 412 trains the neural network in a second training stage with the second training set.

Process 400 may then end or be repeated such as to reinforce correct decisions and correct incorrect decisions.

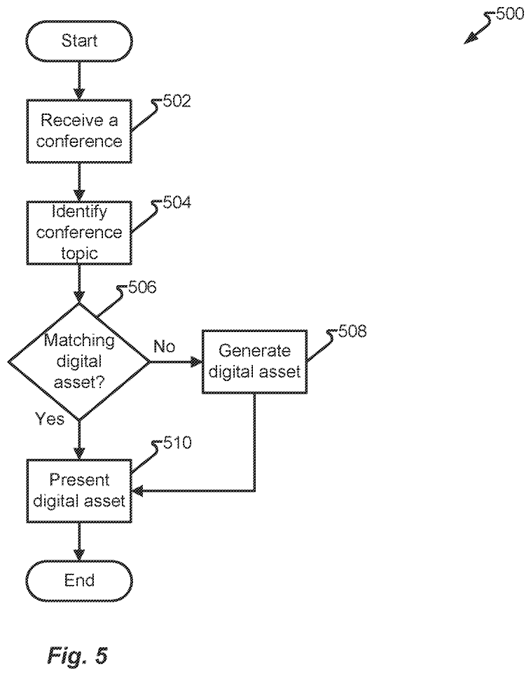

FIG. 5 depicts process 500 in accordance with embodiments of the present disclosure. In one embodiment, process 500 begins and, in step 502, receives a conference. Step 502 may comprise a component (e.g., server 108) monitoring a conference between endpoints (e.g., presenter communication device 104, communication device 114A-C, etc.). Step 504 identifies a conference topic from the received processing, such as by utilizing a microprocessor configured to perform speech recognition and/or recognize other inputs (e.g., the subject of a mouse pointer gesture).

Test 506 determines if there is a match between the conference topic and an existing digital asset. If test 506 is determined in the negative, processing continues to step 508 wherein a digital asset, or plurality of digital assets, is generated. Step 510 presents the existing or generated digital asset, or plurality of digital assets, to the conference as a portion of the conference content.

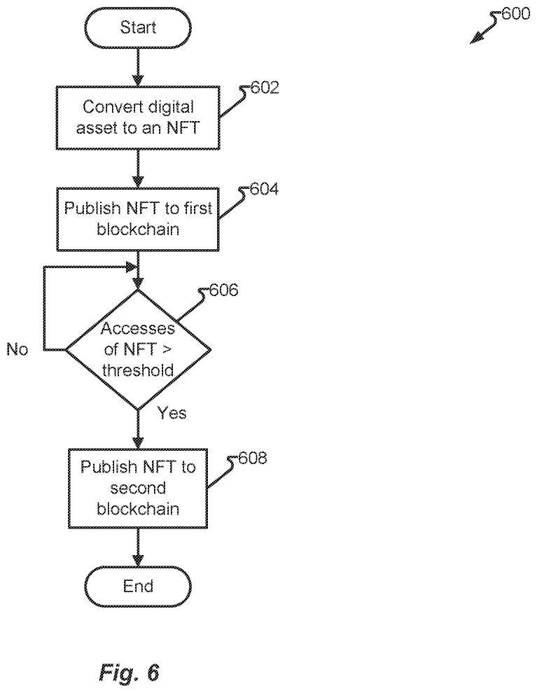

FIG. 6. depicts process 600 in accordance with embodiments of the present disclosure. Once a digital asset is obtained, e.g., as the result of generating the digital asset, it may be added to a repository of digital assets such as to make the digital assets available to subsequent conferences and/or for other purposes. Digital assets may become popular, such as when they provide a concise visual aid to understanding a particular conference topic, or less popular, such as when they are absent clear meaning (e.g., “gibberish”) or otherwise fail to serve as an aid to understanding the conference topic.

In one embodiment, in step 602, process 600 coverts a digital asset to a non-fungible token (NFT). The NFT is published to a first blockchain in step 604. The first blockchain may be to a group within an organization, the organization itself, or other group other than the general public. Test 606 determines if the number of accesses of the NFT is greater than a threshold number of accesses. If so, the NFT is sufficiently popular and, in step 608, the NFT is added to a second blockchain, such as a more widely available or even publicly available blockchain registry. If test 608 is determined in the negative, test 608 may loop back to itself until such time as test 606 is determined in the affirmative. As a further embodiment, test 606 may include an “aging” count, such that any NFT that does not receive a sufficient number of accesses within a previously determined period of time is excluded from being added to the second blockchain. As a further embodiment, one or both of the first and second blockchains may be monetized so as to provide a source of revenue for accesses to the NFT and the embodied digital asset.

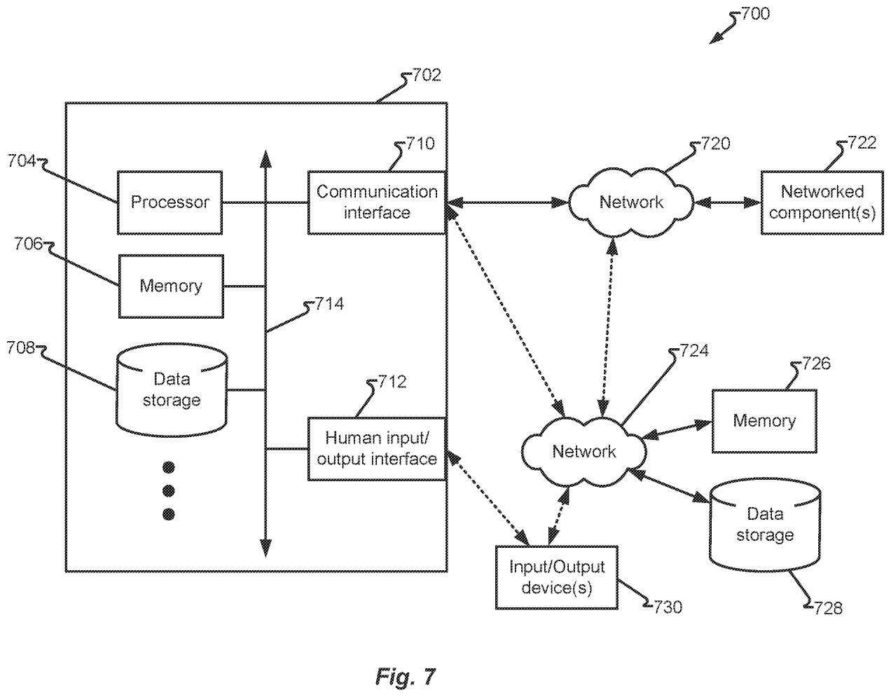

FIG. 7 depicts device 702 in system 700 in accordance with embodiments of the present disclosure. In one embodiment, server 108 may be embodied, in whole or in part, as device 702 comprising various components and connections to other components and/or systems. The components are variously embodied and may comprise processor 704. The term “processor,” as used herein, refers exclusively to electronic hardware components comprising electrical circuitry with connections (e.g., pin-outs) to convey encoded electrical signals to and from the electrical circuitry. Processor 704 may comprise programmable logic functionality, such as determined, at least in part, from accessing machine-readable instructions maintained in a non-transitory data storage, which may be embodied as circuitry, on-chip read-only memory, computer memory 706, data storage 708, etc., that cause the processor 704 to perform the steps of the instructions. Processor 704 may be further embodied as a single electronic microprocessor or multiprocessor device (e.g., multicore) having electrical circuitry therein which may further comprise a control unit(s), input/output unit(s), arithmetic logic unit(s), register(s), primary memory, and/or other components that access information (e.g., data, instructions, etc.), such as received via bus 714, executes instructions, and outputs data, again such as via bus 714. In other embodiments, processor 704 may comprise a shared processing device that may be utilized by other processes and/or process owners, such as in a processing array within a system (e.g., blade, multi-processor board, etc.) or distributed processing system (e.g., “cloud”, farm, etc.). It should be appreciated that processor 704 is a non-transitory computing device (e.g., electronic machine comprising circuitry and connections to communicate with other components and devices). Processor 704 may operate a virtual processor, such as to process machine instructions not native to the processor (e.g., translate the VAX operating system and VAX machine instruction code set into Intel® 9xx chipset code to enable VAX-specific applications to execute on a virtual VAX processor). However, as those of ordinary skill understand, such virtual processors are applications executed by hardware, more specifically, the underlying electrical circuitry and other hardware of the processor (e.g., processor 704). Processor 704 may be executed by virtual processors, such as when applications (i.e., Pod) are orchestrated by Kubernetes. Virtual processors enable an application to be presented with what appears to be a static and/or dedicated processor executing the instructions of the application, while underlying non-virtual processor(s) are executing the instructions and may be dynamic and/or split among a number of processors.

In addition to the components of processor 704, device 702 may utilize computer memory 706 and/or data storage 708 for the storage of accessible data, such as instructions, values, etc. Communication interface 710 facilitates communication with components, such as processor 704 via bus 714 with components not accessible via bus 714. Communication interface 710 may be embodied as a network port, card, cable, or other configured hardware device. Additionally or alternatively, human input/output interface 712 connects to one or more interface components to receive and/or present information (e.g., instructions, data, values, etc.) to and/or from a human and/or electronic device. Examples of input/output devices 730 that may be connected to input/output interface include, but are not limited to, keyboard, mouse, trackball, printers, displays, sensor, switch, relay, speaker, microphone, still and/or video camera, etc. In another embodiment, communication interface 710 may comprise, or be comprised by, human input/output interface 712. Communication interface 710 may be configured to communicate directly with a networked component or configured to utilize one or more networks, such as network 720 and/or network 724.

Network 106 may be embodied, in whole or in part, as network 720. Network 720 may be a wired network (e.g., Ethernet), wireless (e.g., WiFi, Bluetooth, cellular, etc.) network, or combination thereof and enable device 702 to communicate with networked component(s) 722. In other embodiments, network 720 may be embodied, in whole or in part, as a telephony network (e.g., public switched telephone network (PSTN), private branch exchange (PBX), cellular telephony network, etc.).

Additionally or alternatively, one or more other networks may be utilized. For example, network 724 may represent a second network, which may facilitate communication with components utilized by device 702. For example, network 724 may be an internal network to a business entity or other organization, whereby components are trusted (or at least more so) than networked components 722, which may be connected to network 720 comprising a public network (e.g., Internet) that may not be as trusted.

Components attached to network 724 may include computer memory 726, data storage 728, input/output device(s) 730, and/or other components that may be accessible to processor 704. For example, computer memory 726 and/or data storage 728 may supplement or supplant computer memory 706 and/or data storage 708 entirely or for a particular task or purpose. As another example, computer memory 726 and/or data storage 728 may be an external data repository (e.g., server farm, array, “cloud,” etc.) and enable device 702, and/or other devices, to access data thereon. Similarly, input/output device(s) 730 may be accessed by processor 704 via human input/output interface 712 and/or via communication interface 710 either directly, via network 724, via network 720 alone (not shown), or via networks 724 and 720. Each of computer memory 706, data storage 708, computer memory 726, data storage 728 comprise a non-transitory data storage comprising a data storage device.

It should be appreciated that computer readable data may be sent, received, stored, processed, and presented by a variety of components. It should also be appreciated that components illustrated may control other components, whether illustrated herein or otherwise. For example, one input/output device 730 may be a router, a switch, a port, or other communication component such that a particular output of processor 704 enables (or disables) input/output device 730, which may be associated with network 720 and/or network 724, to allow (or disallow) communications between two or more nodes on network 720 and/or network 724. One of ordinary skill in the art will appreciate that other communication equipment may be utilized, in addition or as an alternative, to those described herein without departing from the scope of the embodiments.

In the foregoing description, for the purposes of illustration, methods were described in a particular order. It should be appreciated that in alternate embodiments, the methods may be performed in a different order than that described without departing from the scope of the embodiments. It should also be appreciated that the methods described above may be performed as algorithms executed by hardware components (e.g., circuitry) purpose-built to carry out one or more algorithms or portions thereof described herein. In another embodiment, the hardware component may comprise a general-purpose microprocessor (e.g., CPU, GPU) that is first converted to a special-purpose microprocessor. The special-purpose microprocessor then having had loaded therein encoded signals causing the, now special-purpose, microprocessor to maintain machine-readable instructions to enable the microprocessor to read and execute the machine-readable set of instructions derived from the algorithms and/or other instructions described herein. The machine-readable instructions utilized to execute the algorithm(s), or portions thereof, are not unlimited but utilize a finite set of instructions known to the microprocessor. The machine-readable instructions may be encoded in the microprocessor as signals or values in signal-producing components by, in one or more embodiments, voltages in memory circuits, configuration of switching circuits, and/or by selective use of particular logic gate circuits. Additionally or alternatively, the machine-readable instructions may be accessible to the microprocessor and encoded in a media or device as magnetic fields, voltage values, charge values, reflective/non-reflective portions, and/or physical indicia.

In another embodiment, the microprocessor further comprises one or more of a single microprocessor, a multi-core processor, a plurality of microprocessors, a distributed processing system (e.g., array(s), blade(s), server farm(s), “cloud”, multi-purpose processor array(s), cluster(s), etc.) and/or may be co-located with a microprocessor performing other processing operations. Any one or more microprocessors may be integrated into a single processing appliance (e.g., computer, server, blade, etc.) or located entirely, or in part, in a discrete component and connected via a communications link (e.g., bus, network, backplane, etc. or a plurality thereof).

Examples of general-purpose microprocessors may comprise, a central processing unit (CPU) with data values encoded in an instruction register (or other circuitry maintaining instructions) or data values comprising memory locations, which in turn comprise values utilized as instructions. The memory locations may further comprise a memory location that is external to the CPU. Such CPU-external components may be embodied as one or more of a field-programmable gate array (FPGA), read-only memory (ROM), programmable read-only memory (PROM), erasable programmable read-only memory (EPROM), random access memory (RAM), bus-accessible storage, network-accessible storage, etc.

These machine-executable instructions may be stored on one or more machine-readable mediums, such as CD-ROMs or other type of optical disks, floppy diskettes, ROMs, RAMs, EPROMs, EEPROMs, magnetic or optical cards, flash memory, or other types of machine-readable mediums suitable for storing electronic instructions. Alternatively, the methods may be performed by a combination of hardware and software.

In another embodiment, a microprocessor may be a system or collection of processing hardware components, such as a microprocessor on a client device and a microprocessor on a server, a collection of devices with their respective microprocessor, or a shared or remote processing service (e.g., “cloud” based microprocessor). A system of microprocessors may comprise task-specific allocation of processing tasks and/or shared or distributed processing tasks. In yet another embodiment, a microprocessor may execute software to provide the services to emulate a different microprocessor or microprocessors. As a result, a first microprocessor, comprised of a first set of hardware components, may virtually provide the services of a second microprocessor whereby the hardware associated with the first microprocessor may operate using an instruction set associated with the second microprocessor.

While machine-executable instructions may be stored and executed locally to a particular machine (e.g., personal computer, mobile computing device, laptop, etc.), it should be appreciated that the storage of data and/or instructions and/or the execution of at least a portion of the instructions may be provided via connectivity to a remote data storage and/or processing device or collection of devices, commonly known as “the cloud,” but may include a public, private, dedicated, shared and/or other service bureau, computing service, and/or “server farm.”

Examples of the microprocessors as described herein may include, but are not limited to, at least one of Qualcomm® Snapdragon® 800 and 801, Qualcomm® Snapdragon® 610 and 615 with 4G LTE Integration and 64-bit computing, Apple® A7 microprocessor with 64-bit architecture, Apple® M7 motion comicroprocessors, Samsung® Exynos® series, the Intel® Core™ family of microprocessors, the Intel® Xeon® family of microprocessors, the Intel® Atom™ family of microprocessors, the Intel Itanium® family of microprocessors, Intel® Core® i5-4670K and i7-4770K 22 nm Haswell, Intel® Core® i5-3570K 22 nm Ivy Bridge, the AMD® FX™ family of microprocessors, AMD® FX-4300, FX-6300, and FX-8350 32 nm Vishera, AMD® Kaveri microprocessors, Texas Instruments® Jacinto C6000™ automotive infotainment microprocessors, Texas Instruments® OMAP™ automotive-grade mobile microprocessors, ARM® Cortex™-M microprocessors, ARM® Cortex-A and ARM926EJS™ microprocessors, other industry-equivalent microprocessors, and may perform computational functions using any known or future-developed standard, instruction set, libraries, and/or architecture.

Any of the steps, functions, and operations discussed herein can be performed continuously and automatically.

The exemplary systems and methods of this invention have been described in relation to communications systems and components and methods for monitoring, enhancing, and embellishing communications and messages. However, to avoid unnecessarily obscuring the present invention, the preceding description omits a number of known structures and devices. This omission is not to be construed as a limitation of the scope of the claimed invention. Specific details are set forth to provide an understanding of the present invention. It should, however, be appreciated that the present invention may be practiced in a variety of ways beyond the specific detail set forth herein.

Furthermore, while the exemplary embodiments illustrated herein show the various components of the system collocated, certain components of the system can be located remotely, at distant portions of a distributed network, such as a LAN and/or the Internet, or within a dedicated system. Thus, it should be appreciated, that the components or portions thereof (e.g., microprocessors, memory/storage, interfaces, etc.) of the system can be combined into one or more devices, such as a server, servers, computer, computing device, terminal, “cloud” or other distributed processing, or collocated on a particular node of a distributed network, such as an analog and/or digital telecommunications network, a packet-switched network, or a circuit-switched network. In another embodiment, the components may be physical or logically distributed across a plurality of components (e.g., a microprocessor may comprise a first microprocessor on one component and a second microprocessor on another component, each performing a portion of a shared task and/or an allocated task). It will be appreciated from the preceding description, and for reasons of computational efficiency, that the components of the system can be arranged at any location within a distributed network of components without affecting the operation of the system. For example, the various components can be located in a switch such as a PBX and media server, gateway, in one or more communications devices, at one or more users' premises, or some combination thereof. Similarly, one or more functional portions of the system could be distributed between a telecommunications device(s) and an associated computing device.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire, and fiber optics, and may take the form of acoustic or light waves, such as those generated during radio-wave and infra-red data communications.

Also, while the flowcharts have been discussed and illustrated in relation to a particular sequence of events, it should be appreciated that changes, additions, and omissions to this sequence can occur without materially affecting the operation of the invention.

A number of variations and modifications of the invention can be used. It would be possible to provide for some features of the invention without providing others.

In yet another embodiment, the systems and methods of this invention can be implemented in conjunction with a special purpose computer, a programmed microprocessor or microcontroller and peripheral integrated circuit element(s), an ASIC or other integrated circuit, a digital signal microprocessor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this invention. Exemplary hardware that can be used for the present invention includes computers, handheld devices, telephones (e.g., cellular, Internet enabled, digital, analog, hybrids, and others), and other hardware known in the art. Some of these devices include microprocessors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein as provided by one or more processing components.

In yet another embodiment, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this invention is dependent on the speed and/or efficiency requirements of the system, the particular function, and the particular software or hardware systems or microprocessor or microcomputer systems being utilized.

In yet another embodiment, the disclosed methods may be partially implemented in software that can be stored on a storage medium, executed on programmed general-purpose computer with the cooperation of a controller and memory, a special purpose computer, a microprocessor, or the like. In these instances, the systems and methods of this invention can be implemented as a program embedded on a personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Embodiments herein comprising software are executed, or stored for subsequent execution, by one or more microprocessors and are executed as executable code. The executable code being selected to execute instructions that comprise the particular embodiment. The instructions executed being a constrained set of instructions selected from the discrete set of native instructions understood by the microprocessor and, prior to execution, committed to microprocessor-accessible memory. In another embodiment, human-readable “source code” software, prior to execution by the one or more microprocessors, is first converted to system software to comprise a platform (e.g., computer, microprocessor, database, etc.) specific set of instructions selected from the platform's native instruction set.

Although the present invention describes components and functions implemented in the embodiments with reference to particular standards and protocols, the invention is not limited to such standards and protocols. Other similar standards and protocols not mentioned herein are in existence and are considered to be included in the present invention. Moreover, the standards and protocols mentioned herein and other similar standards and protocols not mentioned herein are periodically superseded by faster or more effective equivalents having essentially the same functions. Such replacement standards and protocols having the same functions are considered equivalents included in the present invention.

The present invention, in various embodiments, configurations, and aspects, includes components, methods, processes, systems and/or apparatus substantially as depicted and described herein, including various embodiments, subcombinations, and subsets thereof. Those of skill in the art will understand how to make and use the present invention after understanding the present disclosure. The present invention, in various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving ease, and\or reducing cost of implementation.

The foregoing discussion of the invention has been presented for purposes of illustration and description. The foregoing is not intended to limit the invention to the form or forms disclosed herein. In the foregoing Detailed Description for example, various features of the invention are grouped together in one or more embodiments, configurations, or aspects for the purpose of streamlining the disclosure. The features of the embodiments, configurations, or aspects of the invention may be combined in alternate embodiments, configurations, or aspects other than those discussed above. This method of disclosure is not to be interpreted as reflecting an intention that the claimed invention requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate preferred embodiment of the invention.

Moreover, though the description of the invention has included description of one or more embodiments, configurations, or aspects and certain variations and modifications, other variations, combinations, and modifications are within the scope of the invention, e.g., as may be within the skill and knowledge of those in the art, after understanding the present disclosure. It is intended to obtain rights, which include alternative embodiments, configurations, or aspects to the extent permitted, including alternate, interchangeable and/or equivalent structures, functions, ranges, or steps to those claimed, whether or not such alternate, interchangeable and/or equivalent structures, functions, ranges, or steps are disclosed herein, and without intending to publicly dedicate any patentable subject matter.

What is claimed is:

1. A system, comprising:
a data storage;
a microprocessor coupled with a computer memory comprising computer readable instructions;
wherein the microprocessor:
receives a conference comprising conference content encoded therein and exchanged over a network between a plurality of communication devices, wherein the conference content comprises speech from at least one of the plurality of communication devices;
identifies a conference topic from the conference content;
determines a digital asset, from a pool of digital assets, that best matches the conference topic; and
presents the digital asset to the plurality of communication devices as a portion of the conference content.

2. The system of claim 1, wherein the microprocessor determines that the digital asset that best matches the conference topic by providing the conference content to a neural network trained to determine the conference topic from the conference content and select the digital asset best matching the conference topic.

3. The system of claim 2, wherein the neural network is trained, the training comprising a computer-implemented method of training the neural network for conference topic detection, comprising:
collecting a set of words associated with conference topics from a database;
applying one or more transformations to each set of words including substituting a word with a synonymous word, substituting a word with a synonymous phrase, inserting at least one redundant word, or removing at least one redundant word to create a modified set of conference topics;
creating a first training set comprising the collected set of words, the modified set of conference topics, and a set of words unrelated to any of the conference topics;
training the neural network in a first stage using the first training set;
creating a second training set for a second stage of training comprising the first training set and the set of words that are incorrectly determined to be associated with the conference topic after the first stage of training; and
training the neural network in a second stage using the second training set.

4. The system of claim 1, wherein the microprocessor determines that the digital asset that best matches the conference topic is an insufficient match and, in response, provides the conference content to a neural network trained to generate digital assets from the conference topic.

5. The system of claim 4, wherein the neural network is trained, the training comprising a computer-implemented method of training the neural network for digital asset generation comprising:
collecting a set of digital assets associated with prior conference topics from a database;
applying one or more transformations to each set of digital assets including substituting a portion of ones of the set of digital assets with a synonymous digital asset, substituting a graphical element with a synonymous graphical element, inserting at least one graphical element into at least one of the set of digital assets, or removing at least one graphical element from at least one of the set of digital assets to create a modified set of digital assets;
creating a first training set comprising the collected set of digital assets, the modified set of digital assets, and a set of digital assets unrelated to the prior conference topics;
training the neural network in a first stage using the first training set;
creating a second training set for a second stage of training comprising the first training set and the set of digital assets that are incorrectly determined to match a prior conference topic after the first stage of training; and
training the neural network in the second stage using the second training set.

6. The system of claim 5, wherein the set of digital assets comprise previously generated digital assets during previous conferences.

7. The system of claim 4, wherein the microprocessor further generates a non-fungible token encoding therein the digital asset and adds the non-fungible token to a first blockchain.

8. The system of claim 7, wherein the microprocessor, upon determining the non-fungible token has been accessed a number of times that exceeds a previously determined threshold, automatically adds the non-fungible token to a second blockchain.

9. The system of claim 1, wherein the microprocessor determines the digital asset that best matches an attribute of the conference.

10. The system of claim 1, wherein the microprocessor determines the digital asset that best matches an attribute of a current speaking participant of the conference.

11. A computer-implemented method, comprising:
receiving a conference comprising conference content encoded therein and exchanged over a network between a plurality of communication devices, wherein the conference content comprises speech from at least one of the plurality of communication devices;
identifying a conference topic from the conference content;
determining a digital asset, from a pool of digital assets, that best matches the conference topic; and
presenting the digital asset to the plurality of communication devices as a portion of the conference content.

12. The method of claim 11, wherein determining the digital asset that best matches the conference topic comprises providing the conference content to a neural network trained to determine the conference topic from the conference content and select the digital asset best matching the conference topic.

13. The method of claim 12, wherein the neural network is trained, the training comprising a computer-implemented method of training the neural network for conference topic detection, comprising:
collecting a set of words associated with conference topics from a database;
applying one or more transformations to each set of words including substituting a word with a synonymous word, substituting a word with a synonymous phrase, inserting at least one redundant word, or removing at least one redundant word to create a modified set of conference topics;
creating a first training set comprising the collected set of words, the modified set of conference topics, and a set of words unrelated to any of the conference topics;
training the neural network in a first stage using the first training set;
creating a second training set for a second stage of training comprising the first training set and the set of words that are incorrectly determined to have the conference topic after the first stage of training; and
training the neural network in the second stage using the second training set.

14. The method of claim 11, further comprising determining that the digital asset that best matches the conference topic is an insufficient match and, in response, providing the conference content to a neural network trained to generate digital assets from the conference topic.

15. The method of claim 14, wherein the neural network is trained, the training comprising a computer-implemented method of training the neural network for digital asset generation comprising:
collecting a set of digital assets associated with prior conference content from a database;
applying one or more transformations to each set of digital assets including substituting a portion of ones of the set of digital asset with a synonymous digital asset, substituting a graphical element with a synonymous graphical element, inserting at least one graphical element into at least one of the ones of the set of the graphical assets, or removing at least one graphical element from at least one graphical asset to create a modified set of conference content;
creating a first training set comprising the collected set of digital assets, the modified set of digital assets, and a set of digital assets unrelated to the conference content;
training the neural network in a first stage using the first training set;
creating a second training set for a second stage of training comprising the first training set and the set of digital assets that are incorrectly determined to match the conference content after the first stage of training; and
training the neural network in the second stage using the second training set.

16. The method of claim 15, wherein the set of digital assets comprise previously generated digital assets during previous conferences.

17. The method of claim 14, further comprising generating a non-fungible token encoding therein the encoded digital asset and adding the non-fungible token to a first blockchain.

18. The method of claim 17, further comprising, upon determining that the non-fungible token has been accessed a number of times that exceeds a previously determined threshold, automatically adding the non-fungible token to a second blockchain.

19. The method of claim 11, further comprising, upon determining the digital asset that best matches the conference topic, determining the digital asset that best matches at least one of an attribute of the conference or a current speaking participant of the conference.

20. A system, comprising:
means to receiving a conference comprising encoded conference content exchanged over a network between a plurality of communication devices, wherein the conference content comprises speech from at least one of the plurality of communication devices;
means to identify a conference topic from the conference content;
means to determine a digital asset, from a pool of digital assets, that best matches the conference topic; and
means to present the digital asset to the plurality of communication devices as a portion of the conference content.
